(19) United States
(12) Patent Application Publication
(10) Pub. No.: US 2002/0199209 A1
(43) Pub. Date: Dec. 26, 2002

(54) Method and system for controlling interlock of interactive service with data broadcasting

(75) Inventor: Ichiyou Shiga, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/960,301

(22) Filed: Sep. 24, 2001

(30) Foreign Application Priority Data
May 21, 2001 (JP) 2001-151442

(51) Int. Cl. H04N 7/16; G06F 3/00; H04N 5/445; G06F 13/00; H04N 11/00; H04N 7/084; H04N 7/087; H04N 7/08; H04N 7/00; H04N 7/173; G05B 15/00

(52) U.S. Cl. 725/136; 725/135; 725/109; 725/105; 725/39; 348/461; 348/473; 700/1

(57) ABSTRACT

An interactive application in an interactive server for providing an interactive service associated with data broadcasting is automatically synchronized with programming of the data broadcasting. A broadcasting station system acquires information for specifying the interactive service associated with the data broadcasting and information for specifying a service time of the interactive service, and transmits the information to the interactive server. On the other hand, the interactive server receives a set of information for specifying the interactive service and information for specifying the service time of the interactive service from one or plural computers relating to data broadcasting, and extracts a set of information for specifying the interactive service having a relation to this interactive server and information for specifying the service time of the received information for specifying the interactive service. Then, activation or deactivation of the respective interactive services is executed on the basis of the extracted set of the information for specifying the interactive service and the information for specifying the service time.

### TECHNICAL FIELD OF THE INVENTION

The present invention relates to a technology for providing interactive services in digital data broadcasting, more particularly to a technology for synchronizing data broadcasting and interactive services.

### BACKGROUND OF THE INVENTION

At present, in addition to program broadcasting by digital images using a broadcasting satellite, data broadcasting is also carried out. The data broadcasting includes program complement type data broadcasting for delivering detailed data of players at a baseball game relay or data by which a viewer takes part in a quiz program, and an independent type service for delivering a weather forecast or news by only the data broadcasting. Both the program complement type and the independent type include interactive services for receiving a quiz reply from a viewer, ticket reservation request from a viewer and the like. At the beginning of the data broadcasting start, the interactive services are carried out by using the X.28 procedure or TTY procedure interface mounted in a digital television tuner. However, the digital television tuner also comes to have an internet connection function. By this, a number of digital broadcasting interactive centers (hereinafter, there is also a case where they are referred to as internet type interactive centers) are constructed on the internet.

Although interactive services associated with the data broadcasting are provided by an interactive server under management of a broadcasting station when the kinds and the number thereof are small, when a number of interactive services are provided, they are not managed by the broadcasting station but are individually managed by advertisers relating to the interactive services or interactive service providers. Besides, there is also a case where they are outsourced and are constructed in a data center or the like separate from the broadcasting station.

It is necessary that an interactive application of an interactive service using data broadcasting is synchronized with programming of the data broadcasting, and the amount of work for that has been neglected when the interactive server is managed by the broadcasting station. However, in circumstances that a plurality of interactive centers exist at remote places, a large amount of work is needed on this account.

### SUMMARY OF THE INVENTION

Therefore, an object of the present invention is to provide a technology for automatically synchronizing an interactive application in an interactive server for providing an interactive service associated with data broadcasting with programming of the data broadcasting.

A method for controlling interlock of an interactive service with data broadcasting according to a first aspect of the present invention comprises the steps of: acquiring information (for example, service ID and/or interactive application ID in embodiments) for specifying an interactive service associated with data broadcasting and information (for example, service start time and service termination time in the embodiments) for specifying a service time of the interactive service; and transmitting the information for specifying the interactive service and the information for specifying the service time, which are acquired in the acquiring step, to a computer (for example, interactive server 5 in embodiments) for providing the interactive service.

By doing so, the computer for providing the interactive service can judge which service is activated at what time and is stopped at what time. That is, synchronization of the data broadcasting and the interactive service can be realized.

Besides, it is also possible to further comprise a step of deleting or invalidating designation of an inactive interactive service in content information of the data broadcasting if information indicating operating states of interactive services is received from the computer for providing the interactive services.

In this way, by deleting or invalidating the designation of the interactive service which is not activated for some reason although it should have been activated, from the content information of the data broadcasting, it becomes possible to cause a viewer of the data broadcasting not to seek provision of the inactive interactive service.

According to a second aspect of the present invention, a method for controlling interlock of an interactive service with data broadcasting in a computer (for example, interactive server 5 in embodiments) for carrying out the interactive service associated with the data broadcasting comprises the steps of: receiving a set of information for specifying an interactive service and information for specifying a service time of that interactive service from a computer of one or a plurality of broadcasting stations; extracting a set of information for specifying the interactive service having a relation to the computer for carrying out the interactive service and information for specifying the service time of that interactive service by using the received information for specifying the interactive service, and controlling activation and stop of each interactive service on the basis of the extracted set of the information for specifying the interactive service and the information for specifying the service time of that interactive service.

In this way, the interactive server can control the activation and stop of only the interactive service (or application) provided in this interactive server.

Incidentally, the foregoing processing method can also be realized by installing a dedicated program in computer hardware. In this case, this program is stored in a storage medium or a storage device, for example, a flexible disk, a CD-ROM, a magneto-optical disk, a semiconductor memory, a hard disk or the like. Besides, there is also a case where the program is distributed through a network or the like. Incidentally, an intermediate processing result is temporarily stored in a memory.

### BRIEF DESCRIPTION OF THE DRAWINGS

FIG. 1 is a diagram showing an outline of a system according to an embodiment of the present invention;

FIG. 2 is a flowchart showing a processing flow by a control information generator;

FIG. 3 is a diagram showing an example of a programming information table contained in interactive service organization information;

FIG. 4 is a diagram showing an example of an interactive application list table contained in the interactive service organization information;

FIG. 5 is a diagram showing an example of control information for service IDs which represent 101 and 701 ;

FIG. 6 is a diagram showing an example of control information for a service ID which represents 501;

FIG. 7 is a flowchart view showing a processing flow by an interactive server;

FIG. 8 is a flowchart showing a processing flow by a control information receiver;

FIG. 9 is a diagram showing an example of integrated control information;

FIG. 10 is a flowchart showing a processing flow by an interactive service activation processor;

FIG. 11 is a diagram showing an example of a control table;

FIG. 12 is a flowchart showing a processing flow by an interactive service deactivation processor;

FIG. 13 is a flowchart showing a processing flow by a service state transmitter;

FIG. 14 is a diagram an example of a service ID list;

FIG. 15 is a flowchart showing a processing flow by a service state receiver.

### DETAILED DESCRIPTION OF THE PREFERRED EMBODIMENTS

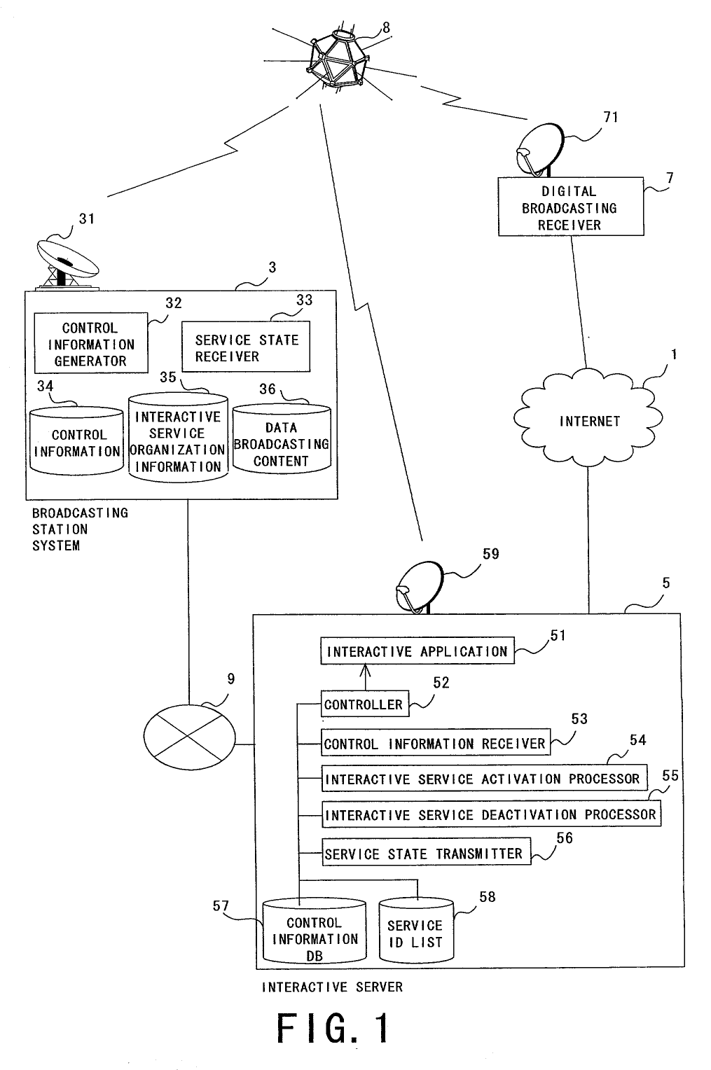

FIG. 1 is a schematic diagram of a system according to an embodiment of the present invention. A broadcasting station system 3 managed and operated by a broadcasting station includes an antenna 31 for transmitting control information to realize synchronization with an interactive application 51 in an interactive server 5 and content information of data broadcasting to a satellite 8, a control information generator 32, a service state receiver 33 for receiving and processing information regarding a service state of the interactive application 51 in the interactive server 5 from the interactive server 5 a control information storage. Unit 34, an interactive service organization information storage unit 35, and a data broadcasting content storage unit 36. Although FIG. 1 shows only one broadcasting system 3, there is also a case where a plurality of broadcasting station systems exist. Since the satellite 8 is a broadcasting satellite and is the same as a conventional one, an explanation will not be given any further. Incidentally, the broadcasting station may be a broadcasting station where data broadcasting is carried out by a terrestrial broadcasting, not satellite broadcasting.

A digital broadcasting receiver 7 is connected to an antenna 71 , and can receive the data broadcasting from the satellite 8 and can display it on a display device. Besides, it has, for example, a function to connect with the Internet 1. Incidentally, although FIG. 1 shows only one digital broadcasting receiver 7, a plurality of receivers exist. Since the digital broadcasting receiver 7 of this embodiment is the same as a conventional one, an explanation will not be given any further.

The interactive server 5 installed in an interactive center is connected to the Internet 1 and an antenna 59, and includes one or a plurality of interactive applications 51 for providing interactive services to the digital broadcasting receiver 7 through, for example, the Internet 1, a controller 52 for carrying out the control of activation and stop of the interactive application 51, a control information receiver 53 for receiving and processing control information from one or a plurality of broadcasting systems 3, an interactive service activation processor 54 for carrying out a processing to activate the interactive services, an interactive service deactivation processor 55 for carrying out a processing to terminate the interactive services, a service state transmitter 56 for generating information relating to a service state of the interactive application 51 and transmitting it to the broadcasting station system 3, a control information database (DB) 57 for storing information relating to the control information, and a service ID list storage unit 58 for storing the service ID list generated by the service state transmitter 56. The interactive server 5 is connected to the broadcasting station system 3 through, for example, a public line network 9. Incidentally, there is also a case where it is connected to the broadcasting station system 3 through the Internet 1. Although FIG. 1 shows only one interactive server, there is also a case where one or a plurality of interactive servers 5 are provided in the interactive center, and there is also a case where one of a plurality of interactive centers are provided.

Here, the operation of the system shown in FIG. 1 will be described in brief. The control information generator 32 of the broadcasting station system 3 extracts information (such as interactive application ID, service ID, service start time, and service termination time) of the interactive service from the interactive service organization information. Here, the service ID is equivalent to a channel number of a broadcasting station. The interactive application ID is equivalent to a URL (Uniform Resource Locator) of a CGI (Common Gateway Interface) program. The control information generator 32 checks inconsistency between the extracted information and data broadcasting content. Then, it generates control information including the service ID, the interactive application ID, the service start time, the service termination time, and information of a program flag indicating whether or not the interactive application must be activated at the moment, and stores it in the control information storage unit 34.

The control information generator 32 transmits the generated control information to the interactive server 5. There is a case where the control information, together with, for example, the data broadcasting content, is transmitted from the antenna 31 to the satellite 8 and is transmitted from the satellite 8 to the antenna 59 connected to the interactive server 5, or there is also a case where only the control information is transmitted through, for example, the public line network 9. Incidentally, the transmission is performed at any time.

When receiving control information from one or a plurality of broadcasting station systems 3, the control information receiver 53 of the interactive server 5 combines them to generate integrated control information and stores it in the control information DB 57. The interactive service activation processor 54 and the interactive service deactivation processor 55 extract only the control information of the interactive application 51 executed in the interactive server 5 from the integrated control information, generate a control table, and update the program flag indicating whether or not the interactive application must be activated, in accordance with the present time. The control table is stored in the control information DB 57. Then, the controller 52 activates the interactive application 51 in which the program flag is ON and which is not activated yet, and stops the interactive application 51 in which the program flag is OFF and which is not stopped yet.

By doing so, it becomes possible to realize synchronization of the data broadcasting and the interactive application for carrying out the interactive service. That is, it becomes possible to activate and deactivate the interactive application at a suitable timing. By this, even in the case where the same broadcasting content is broadcasted from a plurality of broadcasting stations with time difference, it becomes possible to easily carry out the interactive service interlocking with a broadcasting program. For example, it becomes possible to easily deal with a program participation type interactive program such as a quiz.

The service state transmitter 56 performs the interactive application 51 for a response test, in which the program flag is ON according to the control table, generates a service ID list indicating the result of the response test, and transmits it to the broadcasting station system 3. The service ID list is stored in the service ID list storage unit 58. When receiving the service ID list from the interactive server 5, the service state receiver 33 of the broadcasting station system 3 invalidates or deletes the designation of the interactive application which is not activated in the data broadcasting content.

By this, since it becomes impossible for a viewer of the digital broadcasting receiver 7 to select the interactive application which is not activated for some reason although it should have been activated, wasteful access to the interactive server 5 comes not to occur, so that payment of a wasteful communication fee can be avoided.

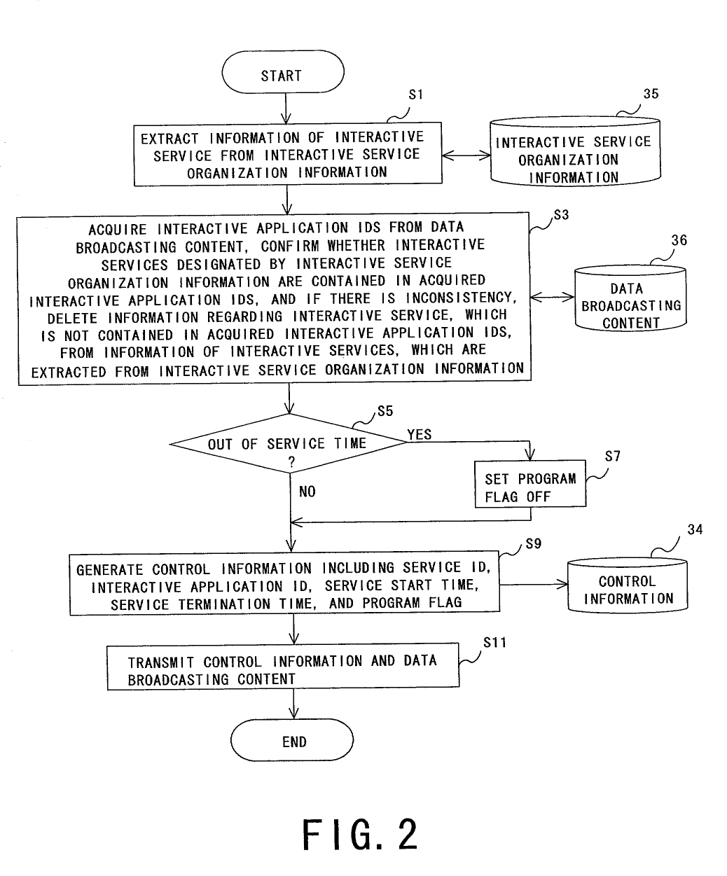

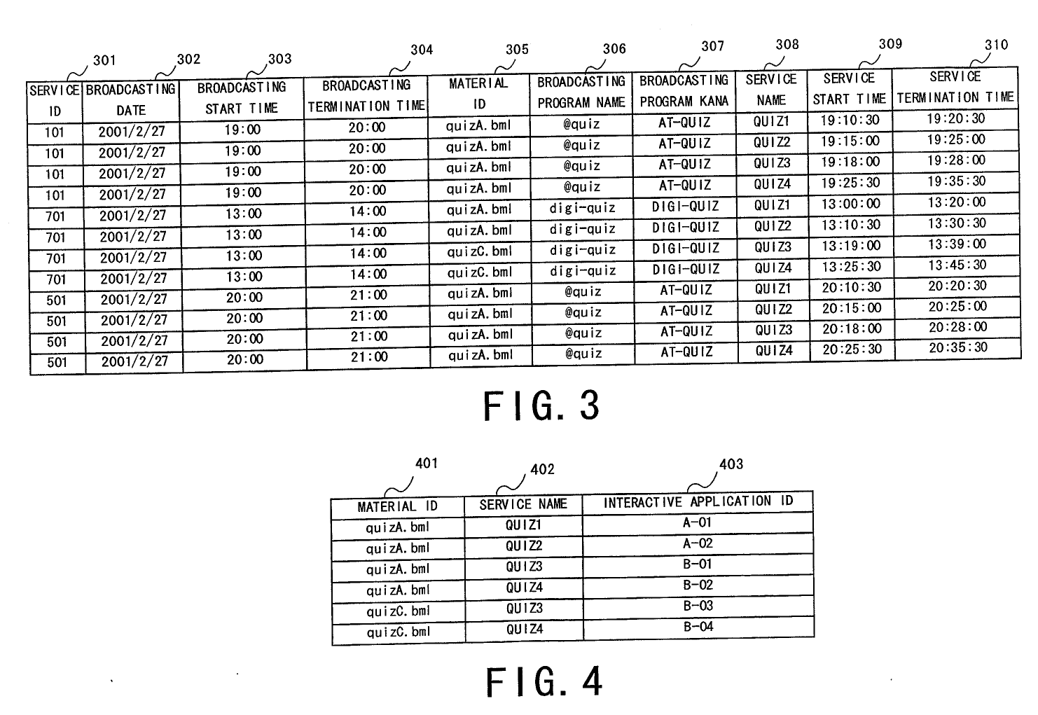

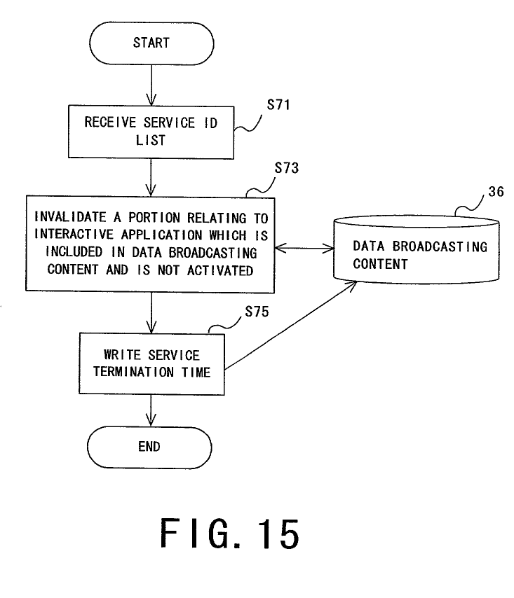

Next, the details of the processing will be described with reference to FIGS. 2 to 15. First, the processing flow in the broadcasting station system 3 will be described with reference to FIG. 2. The control information generator 32 of the broadcasting station system 3 extracts the information of the interactive services from the interactive service organization information stored in the interactive service organization information storage unit 35 (step S1). FIG. 3 shows an example of a programming information table contained in the interactive service organization information, and FIG. 4 shows an example of an interactive application list table thereof. As shown in FIG. 3, the programming information table includes a column 301 of a service ID equivalent to a channel number, a column 302 of a broadcasting date, a column 303 of a broadcasting start time, a column 304 of a broadcasting termination time, a column 305 of a material ID as an ID of content information described in BML (Broadcast Markup Language) for data broadcasting, a column 306 of a broadcasting program name, a column 307 of a broadcasting program kana display, a column 308 of a service name of an interactive service, a column 309 of a service start time of the interactive service, and a column 310 of a service termination time. Besides, the interactive application list table includes, as shown in FIG. 4, a column 401 of a material ID, a column 402 of a service name, and a column 403 of an interactive application ID corresponding to those. At step S1, the control information generator 32 acquires a set of the interactive application ID, the service ID, the service start time, and the service termination time.

Again in FIG. 2, the control information generator 32 acquires the interactive application IDs from the data broadcasting content stored in the data broadcasting content storage unit 56, confirms whether the interactive services designated by the interactive service organization information are contained in the acquired interactive application IDs, and if there is inconsistency, deletes information regarding the interactive service, which is not contained in the acquired interactive application IDs, from the information of the interactive services, which are extracted from the interactive service organization information (step S3). That is, the interactive application which is not designated in the data broadcasting content although it is contained in the interactive service organization information is treated as one in which service is not carried out. Incidentally, there is also a case where an interactive application exists which is designated in the data broadcasting content although it is not contained in the interactive service organization information, and in this case, if information to generate the control information can be obtained from the data broadcasting content or the like, it may be additionally processed.

Here, an example (only a part) of the data broadcasting content will be given.

TABLE 1

| | |
|---|---|
| 01 | <?bml bml-version“1.0”?> |
| 02 | <bml> |
| 03 | <title/> |
| 04 | <form name=quiz01 ACTION=http://www.a-center.com/A01.cgi> |
| 05 | <B>quiz1:</B> |
| 06 | <INPUT TYPE=“text” name=“quiz01_ input” VALUE=“” SIZE=“1” MAXLENGTH=“1” |
| 07 | style=“font-size:20px; left:120px; top:0px; width:300px; height:25px”/> |
| 08 | |
| 09 | </form> |
| 10 | <form name=quiz02 ACTION=http://www.a-center.com/A02.cgi> |
| 11 | <B>quiz2:</B> |
| 12 | <INPUT TYPE=“text” name=“quiz01_ input” VALUE=“” SIZE=“1” MAXLENGTH=“1” |
| 13 | style=“font-size:20px; left:120px; top:0px; width:300px; height:25px”/> |
| 14 | |
| 15 | </form> |
| 16 | <form name=quiz03 ACTION=http://www.b-center.com/B01.cgi> |
| 17 | <<omitted>> |
| 18 | <form> |
| 19 | <form name=quiz04 ACTION=http://www.b-center.com/B02/cgi> |
| 20 | <<omitted>> |
| 21 | </form> |
| 22 | </bml> |

In Table 1, the numbers at the left are added only for explanation. The first line is a declaration sentence of BML, and the lines 2 to 22 are substantial portions. The attribute value of ACTION of the form tag is the interactive application ID. The lines 4 to 9 are a portion for prescribing the contents of the interactive service of quiz01, the lines 10 to 15 are a portion for prescribing the contents of the interactive service of quiz02, the lines 16 to 18 are a portion for prescribing the contents of the interactive service of quiz03, and the lines 19 to 21 are a portion for prescribing the contents of the interactive service of quiz04. Since the details of the tag are irrelevant to the gist of this embodiment, an explanation is not given any further.

At step S3, the control information generator 32 acquires the attribute value of ACTION of the form tag to acquire the interactive application ID, and checks it with the interactive application ID extracted from the interactive service organization information. Among the interactive application IDs extracted from the interactive service organization information, one which is not coincident with the interactive application ID extracted from the data broadcasting content is deleted.

Next, the control information generator 32 judges whether, with respect to each of the interactive application IDs, the present time is out of a service time prescribed by the service start time and the service termination time (step S5). With respect to the interactive application ID in which the present time is judged to be out of the service time, its program flag is set OFF. Incidentally, it is assumed that program flags of all interactive application IDs are set ON at first.

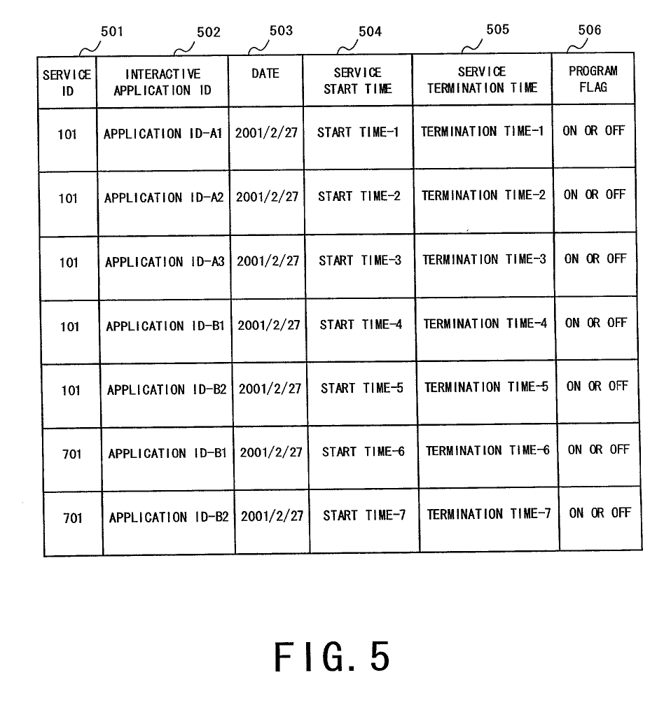

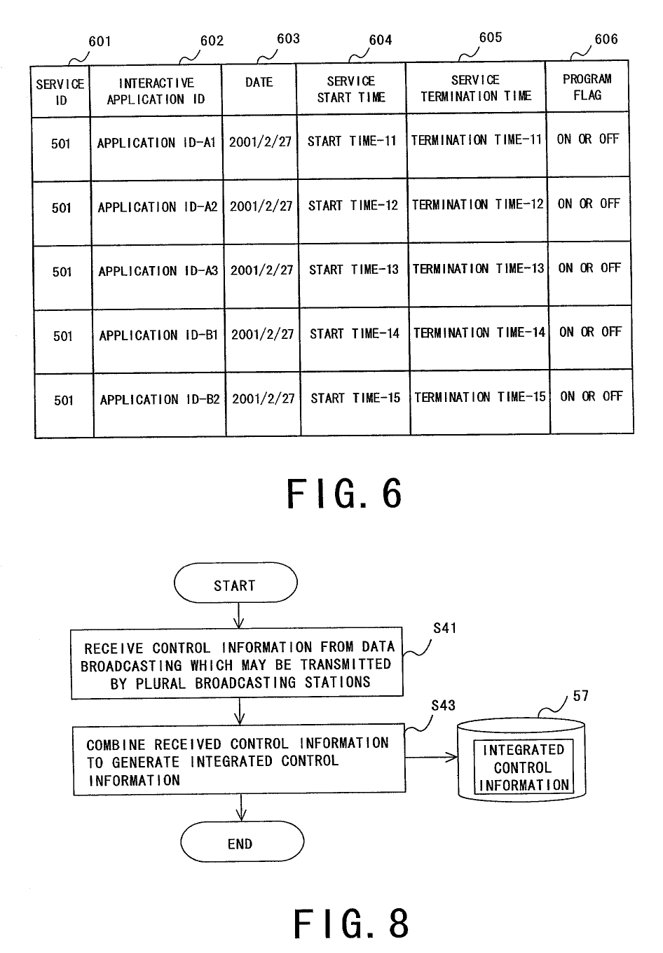

The control information generator 32 generates the control information including the service ID, the interactive application ID, the service start time, the service termination time, and the program flag, and stores it in the control information storage unit 34 (step S9). For example, the control information as shown in FIG. 5 and FIG. 6 is generated. FIG. 5 shows the control information for the service IDs 101 and 701, and FIG. 6 shows the control information for the service ID 501. For example, the control information of FIG. 5 is generated in a first broadcasting station system, and that of FIG. 6 is generated in a second broadcasting station system.

The control information shown in FIG. 5 includes a column 501 of a service ID, a column 502 of an interactive application ID, a column 503 of a date, a column 504 of a service start time, a column 505 of a service termination time, and a column 506 of a program flag. Similarly, the control information shown in FIG. 6 includes a column 601 of a service ID, a column 602 of an interactive application ID, a column 603 of a date, a column 604 of a service start time, a column 605 of a service termination time, and a column 606 of a program flag.

The broadcasting station system 3 distributes the control information stored in the control information storage unit 34 and the data broadcasting content stored in the data broadcasting content storage unit 36 through the antenna 31 and the satellite 8 (step S1). Incidentally, the distributed control information is neglected in the digital broadcasting receiver 7. Besides, the control information may be transmitted to the interactive server 5 through, for example, the public line network 9.

Like this, by transmitting the information (service ID and interactive application ID) for specifying the interactive service and the information (service start time, service termination time, date (in the case where the date is separately designated) for specifying the service time to the interactive server 5, it becomes possible to automatically carry out the processing for realizing synchronization with the data broadcasting in the interactive server 5.

Besides, since the interactive application ID in the interactive service organization information is confirmed by comparing with the data broadcasting content, it becomes possible to suitably interlock the data broadcasting content with the interactive application.

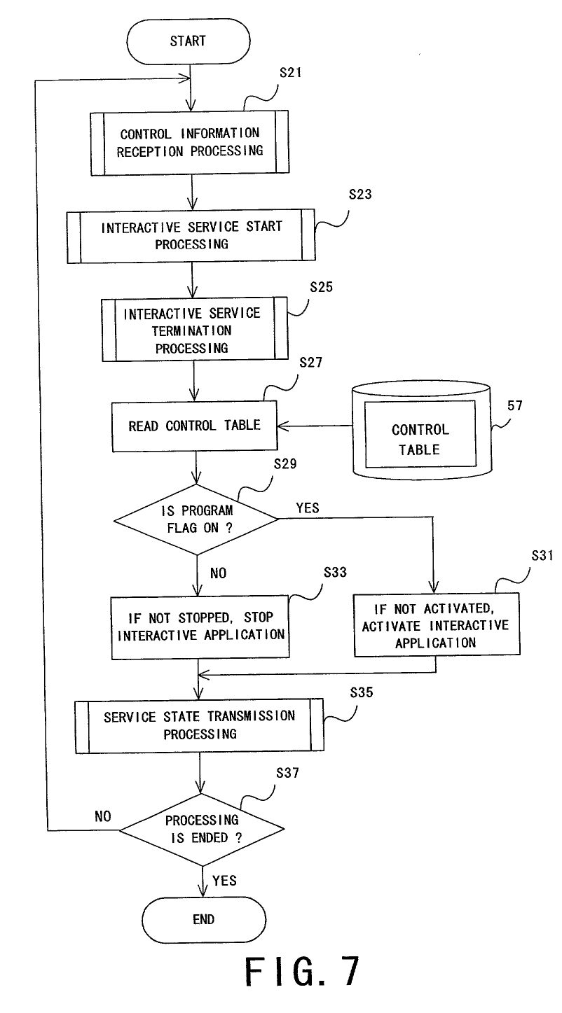

Next, the processing flow of the interactive server 5 will be described with reference to FIGS. 7 to 14. At first, the main processing flow of the interactive server 5 will be described with reference to FIG. 7. The processing flow of FIG. 7 is controlled by the controller 52. First, the control information receiver 53 carries out a control information reception processing (step S21). Although this control information reception processing will be described later in detail, by this processing, the control information is received from one or a plurality of broadcasting station systems 3, and the integrated control information is generated. The interactive service activation processor 54 carries out an interactive service start processing (step S23). Although this interactive service start processing will also be described later in detail, the control information of the interactive application 51 in the interactive server 5 is extracted by this processing to generate the control table, and in the control table, the program flag of the interactive application in which the service start time has arrived is set ON. Further, the interactive service deactivation processor 55 carries out an interactive service termination processing (step S25). Although this interactive service termination processing will also be described later in detail, in the control table, the program flag of the interactive application in which the service termination time has arrived is set OFF by this processing.

The controller 52 reads out the control table after the processing is performed up to step 25 (step S27), and checks the program flag of the respective interactive application ID (step S29). If the program flag is ON (step S29: Yes route), and if the interactive application 51 is not activated, it is activated (step S31). If activated, it is left as it is. On the other hand, in the case where the program flag is OFF (step S29: No route), and if the interactive application 51 is not stopped, it is stopped (step S33). If stopped, it is left as it is.

By this, the interactive application 51 to be activated is activated, and the interactive service is provided in response to a request from the digital broadcasting receiver 7. On the other hand, the interactive application 51 in which the service time is terminated is stopped.

Next, the service state transmitter 56 carries out a service state transmission processing (step S35). The service state transmission processing will also be described later in detail. The processing from the step S21 to the step S35 is repeated until the processing is terminated by the controller 52 (step S37).

Next, the control information reception processing by the control information receiver 53 will be described with reference to FIG. 8. The control information receiver 53 receives the control information by data broadcasting or the like from one or a plurality of broadcasting station systems 3, and stores it in the control information DB 57 (step S41). Although described above, there is a case where the plurality of broadcasting station systems 3 exist, and the respective broadcasting station systems 3 transmit the control information, together with the data broadcasting content, to the interactive server 5 through an electric wave or separately through a communication line such as the public line network 9. Then, the plural pieces of received control information are combined to generate the integrated control information, which is stored in the control information DB 57 (step S43).

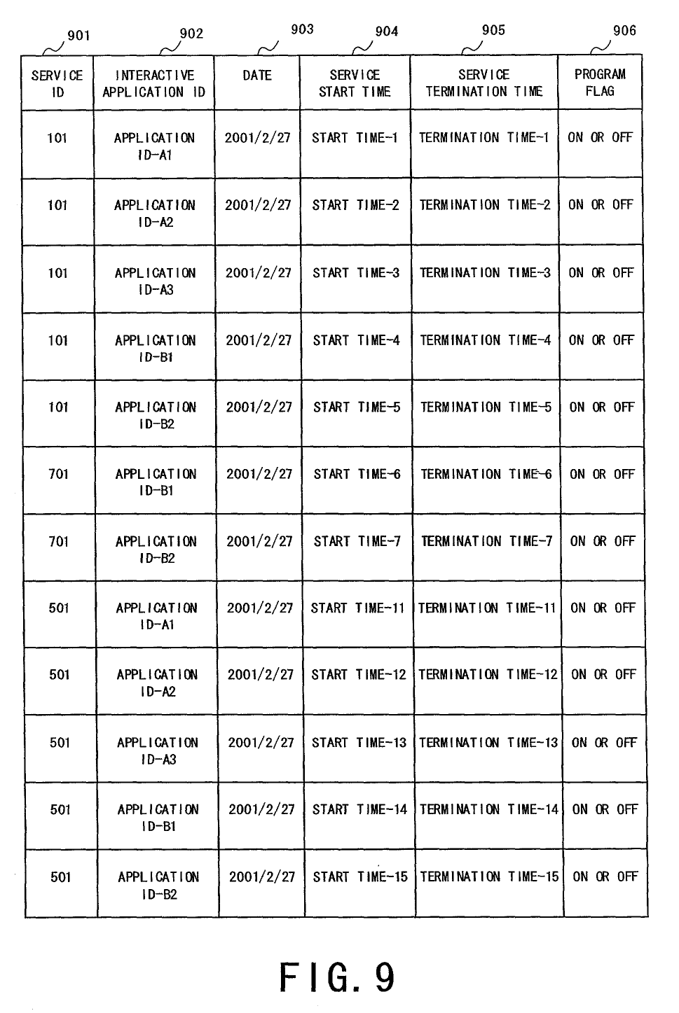

FIG. 9 shows an example of the integrated control information. The integrated control information is obtained by simply combining the plural pieces of control information. In the example of FIG. 9, the control information of FIG. 5 transmitted from the first broadcasting station system and the control information of FIG. 6 transmitted by the second broadcasting station system are combined, and the integrated control information is generated. Like the control information, the integrated control information includes a column 901 of a service ID, a column 902 of an interactive application ID, a column 903 of a date, a column 904 of a service start time, a column 905 of a service termination time, and a column 906 of a program flag. Incidentally, there are included a line in which the service ID is 101 and the interactive application ID is application ID-A1, a line in which the service ID is 101 and the interactive application ID is application ID-A2, a line in which the service ID is 101 and the interactive application ID is application ID-A3, a line in which the service ID is 101 and the interactive application ID is application ID-B1, a line in which the service ID is 101 and the interactive application ID is application ID-B2, a line in which the service ID is 701 and the interactive application ID is application ID-B1, a line in which the service ID is 701 and the interactive application ID is application ID-B2, a line in which the service ID is 501 and the interactive application ID is application ID-A1, a line in which the service ID is 501 and the interactive application ID is application ID-A2, a line in which the service ID is 501 and the interactive application ID is application ID-A3, a line in which the service ID is 501 and the interactive application ID is application ID-B1, and a line in which the service ID is 501 and the interactive application ID is application ID-B2.

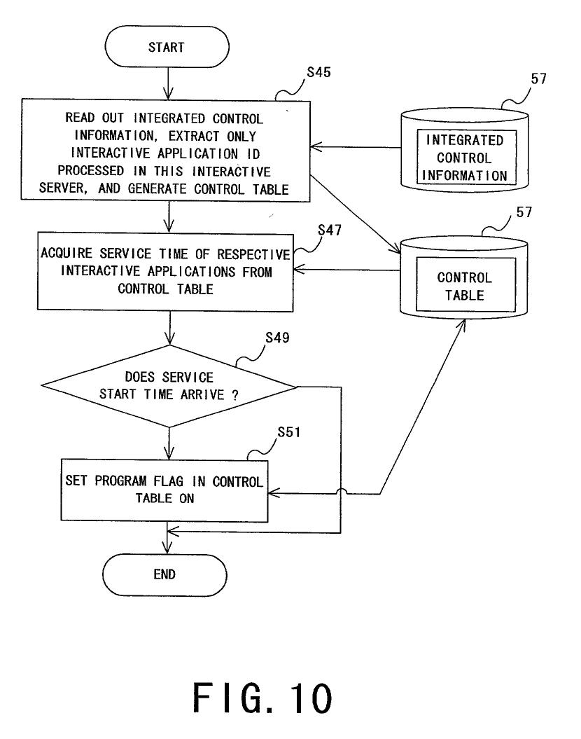

Next, the interactive service start processing by the interactive service activation processor 54 will be described with reference to FIG. 10. The interactive service activation processor 54 reads out the integrated control information stored in the control information DB 57, extracts only information relating to the ID of the interactive application 51 executed in this interactive center (or this interactive server), and generates the control table (step S45). The control table is stored in the control information DB 57.

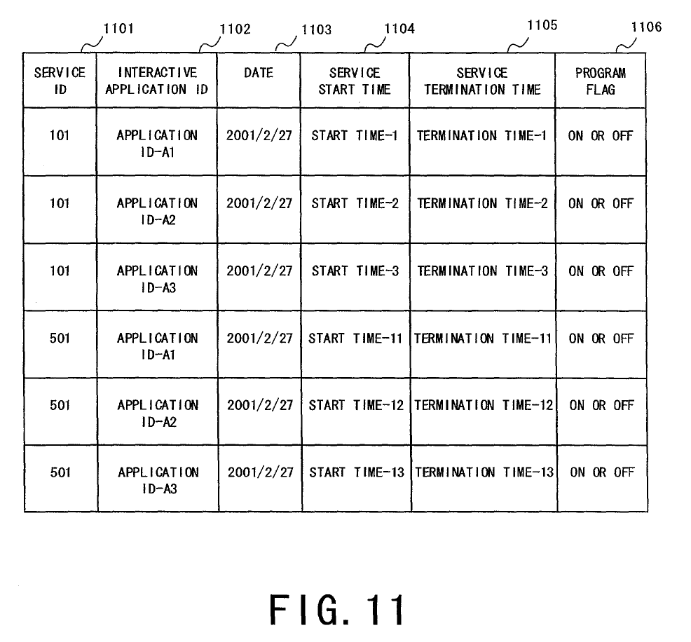

FIG. 11 shows an example of the control table. In the case where the integrated control information as shown in FIG. 9 is generated, and only the interactive application IDs of application ID-A1, application ID-A2, and application ID-A3 are the interactive applications executed in the interactive server 5, the control table as in FIG. 11 is generated. The control table includes a column 1101 of a service ID, a column 1102 of an interactive application ID, a column 1103 of a date, a column 1104 of a service start time, a column 1105 of a service termination time, and a column 1106 of a program flag. Besides, there are included a line in which the service ID is 101 and the interactive application ID is application ID-Al, a line in which the service ID is 101 and the interactive application ID is application ID-A2, a line in which the service ID is 101 and the interactive application ID is application ID-A3, a line in which the service ID is 501 and the interactive application ID is application ID-A1, a line in which the service ID is 501 and the interactive application ID is application ID-A2, and a line in which the service ID is 501 and the interactive application ID is application ID-A3.

Next, the interactive service activation processor 54 acquires information of the service time (service start time and service termination time) of the respective interactive applications from the control table (step S47). Then, it is confirmed whether the present time becomes the service start time (step S49). With respect to the interactive application in which it is judged that the present time becomes the service start time prescribed in the control table (step S49: Yes route), the program flag corresponding to that interactive application ID is set ON (step S51). Incidentally, if it is already ON, anything is not done. On the other hand, with respect to the interactive application in which it is judged that the present time does not become the service start time prescribed in the control table (step S49: No route), anything is not done and the processing is ended.

In this way, the control table including only the control information relating to this interactive server 5 is generated, and the processing for making the program flag ON is carried out.

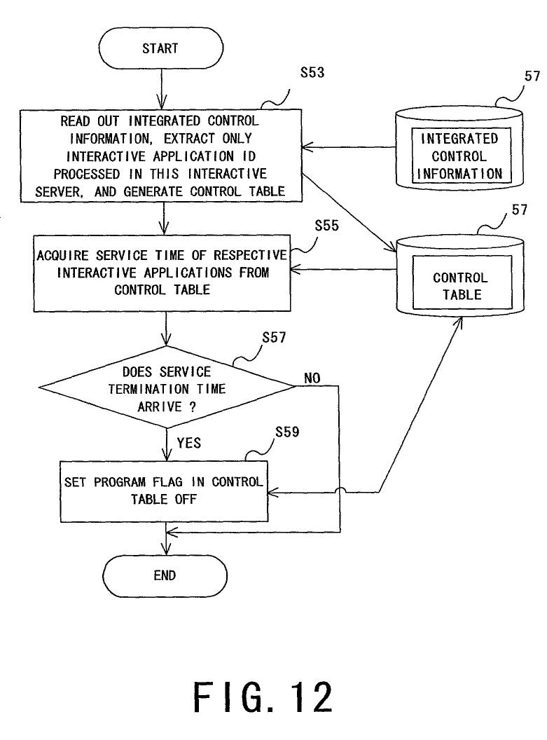

Next, the interactive service termination processing by the interactive service deactivation processor 55 will be described with reference to FIG. 12. The interactive service deactivation processor 55 reads out the integrated control information stored in the control information DB 57, extracts only the information relating to the ID of the interactive application 51 executed in this interactive center (or this interactive server), and generates the control table (step S53). The control table is stored in the control information DB 57. Incidentally, since this step is already carried out in the interactive service activation processor 54, it may not be carried out. Here, on the assumption that there is a possibility that the interactive service termination processing is separately carried out, the step S53 is included.

The interactive service deactivation processor 55 acquires information of the service time (service start time and service termination time) of the respective interactive applications from the control table (step S55). Then, it is confirmed whether the present time becomes the service termination time (step S57). With respect to the interactive application in which it is judged that the present time becomes the service termination time prescribed in the control table (step S57: Yes route), the program flag corresponding to that interactive application ID is set OFF (step S59). Incidentally, if it is already OFF, anything is not done. On the other hand, with respect to the interactive application in which it is judged that the present time does not become the service termination time prescribed in the control table (step S57: No route), anything is not done and the processing is ended.

In this way, the control table including only the control information relating to this interactive server 5 is generated, and the processing for making the program flag OFF is carried out.

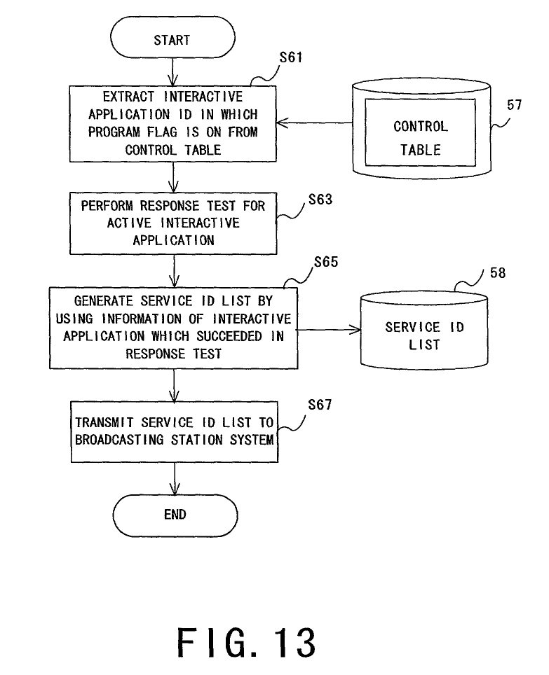

Next, the service state transmission processing by the service state transmitter 56 of the interactive server 5 will be described with reference to FIG. 13. The service state transmitter 56 reads out the control table stored in the control information DB 57, and extracts from the control table the interactive application ID in which the program flag is ON (step S61). Then, a response test is carried out correspondingly to the interactive application in which the program flag is ON, that is, the active interactive application (step S63). The response test may be a test in which whether a response is made, for example, ping, or may be a test for confirming whether an expected processing is carried out.

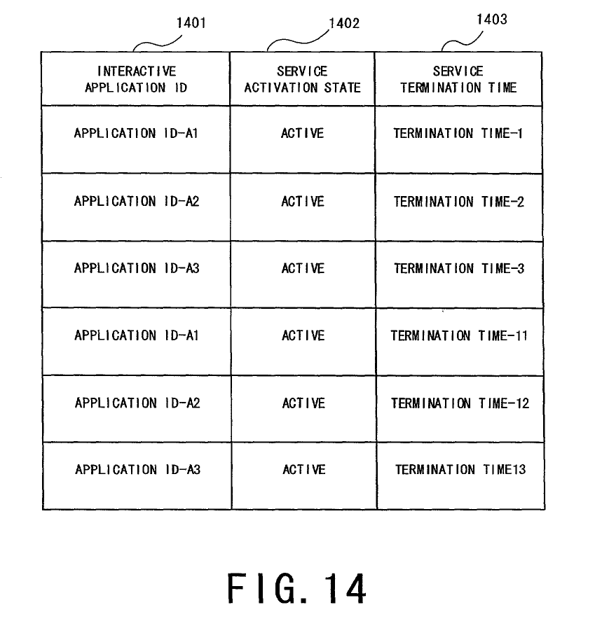

The service state transmitter 56 generates a service ID list using the information of the interactive application in which the response test succeeded, and stores it in the service ID list storage unit 58 (step S65). FIG. 14 shows an example of the service ID list. The example of FIG. 14 includes a column 1401 of an interactive application ID, a column 1402 of a service activation state, and a column 1403 of a service termination time. Incidentally, the column 1402 of the service activation state may not be necessarily included since the list relates to only the interactive application which has been activated and in which the response test succeeded.

The service state transmitter 56 transmits the generated service ID list to the broadcasting station system 3 through, for example, the public line network 9 (step S67). By this, the broadcasting station system 3 can acquire the information of the active interactive application, and can update the data broadcasting content.

Next, the processing of the service state receiver 33 of the broadcasting station system 3 will be described with reference to FIG. 14. First, the service state receiver 33 receives the service ID list from the interactive server 5 through the public line network 9 or the like (step S71). Then, the service state receiver 33 invalidates a part relating to the interactive application which is the interactive application contained in the data broadcasting content stored in the data broadcasting content storage unit 36 and is not active (step S73). For example, in the f the data broadcasting content as shown in Table 1, corrections as described are added.

TABLE 2

| | |
|---|---|
| 31 | <?bmL bml-version=“1.0”?> |
| 32 | <bml> |
| 33 | <title1> |
| 34 | <form name=quiz01 ACTION=http://www.a-center.com/A01.cgi> |
| 35 | <B>quiz1:</B> |
| 36 | <INPUT TYPE=“text” name=“quiz01_ input” VALUE=“” SIZE=“1” MAXLENGTH=“1” |
| 37 | style=“font-size:20px; left:120px; top:0px; width:300px; height:25px”/> |
| 38 | |
| 39 | </form> |
| 40 | <!- |
| 41 | <form name=quiz02 ACTION= http://www.a-center.com/A02.cgi> |
| 42 | <B>quiz2:</B> |
| 43 | <INPUT TYPE=“text” name=“quiz01_input” VALUE=“” SIZE=“1” MAXLENGTH=“1” |
| 44 | style=“font-size:20px; left:120px; top:0px; width:300px; height:25px”/> |
| 45 | |
| 46 | </form> |
| 47 | --> |
| 48 | <!- |
| 49 | <form name=quiz03 ACTION=http://www.b-center.com/B01.cgi> |
| 50 | <<omitted>> |
| 51 | </form> |
| 52 | --> |
| 53 | <!- |
| 54 | <form name=quiz04 ACTION=http://www.b-center.com/B02/cgi> |
| 55 | <<omitted>> |
| 56 | </form> |
| 57 | --> |
| 58 | </bml> |

The numbers at the left end of Table 2 are given for only explanation, and are not normally contained. Table 2 shows an example in which only the information of the interactive application ID “http://www.a-center.com/A01.cgi” is contained in the service ID list, and the three remaining interactive application IDs are not contained in the service ID list. In this case, “<!-” and “- ->” for disabling the designation of the interactive application of quiz02 are added at lines 40 and 47, “<!-” and “- ->” for disabling the designation of the interactive application of quiz03 are added at lines 48 and 52, and “<!-” and “-->” for disabling the designation of the interactive application of quiz04 are added at lines 53 and 57. Incidentally, the contents of the lines 40 to 57 be deleted, not disabled.

The service state receiver 33 may write the information of the service termination time contained in the service ID list into the data broadcasting content correspondingly to the interactive application ID contained in the service ID list (step S75). Incidentally, a time period up to the service termination time is calculated and its information may be written into the data broadcasting content.

In this way, since the data broadcasting content is corrected and the information of the inactive interactive application is disabled, the digital broadcasting receiver 7 can not also select the interactive application which is not active, and wasteful connection to the Internet 1 is avoided.

Incidentally, although in the foregoing example, only the information of the activated interactive application is contained in the service ID list, it is also possible to contain the information of the interactive application which fails the response test although it must be activated.

Although an embodiment has been described, the present invention is not limited to this. For example, although the control information generated by the control information generator 32 contains the program flags as shown in FIG. 5 and FIG. 6, such flags may not be contained. Similarly the program flags may be also not contained in the integrated control information. Besides, although the control information generator 32 generates the control information on the basis of the interactive service organization information, the control information may be generated on the basis of information other than the interactive service organization information.

The function blocks as shown in FIG. 1 are an example, and other deviation of the function blocks may be adopted. Further, the way of dividing the data stored in the storage device is also arbitrary. With respect to the interactive server 5, necessary functions may be realized by not one computer, but a plurality of computers. The broadcasting station system 3 can also be constructed by one or a plurality of computers.

As described above, the present invention can provide technology in circumstances in which the packet charging is performed, to properly charge the receiving fee for a particular packet data to a sender of the particular packet data.

What is claimed is:

1. A method for controlling interlock of an interactive service with data broadcasting, said method comprising the steps of:
acquiring information for specifying an interactive service associated with data broadcasting and information for specifying a service time of said interactive service;
transmitting said information for specifying said interactive service and said information for specifying said service time, which are acquired in said acquiring step, to a computer for providing said interactive service.

2. The method as set forth in claim 1, wherein said acquiring step includes a step of extracting said information for specifying said interactive service and said information for specifying said service time from interactive service organization information.

3. The method as set forth in claim 2, wherein said acquiring step further includes a step of extracting second information for specifying said interactive service from content information of said data broadcasting and comparing the second extracted information with said information for specifying said interactive service extracted from said interactive service organization information.

4. The method as set forth in claim 1, wherein in said transmitting step, said information for specifying said interactive service and said information for specifying said service time, together with content information of said data broadcasting, are distributed to said computer for providing said interactive service.

5. The method as set forth in claim 1, further comprising a step of generating information as to whether each interactive service must be activated at present based on said information for specifying said service time of each said interactive service, and
wherein in said transmitting step, said information as to whether each said interactive service must be activated at present is further transmitted.

6. The method as set forth in claim 1, further comprising a step of, if information indicating an operating state of said interactive service is received from said computer for providing said interactive service, deleting or invalidating designation of an inactive interactive service in content information of said data broadcasting.

7. A method for controlling interlock of an interactive service with data broadcasting m a computer for carrying out said interactive service associated with said data broadcasting, said method comprising the steps of:
receiving a set of information for specifying an interactive service and information for specifying a service time of said interactive service from a computer in one or a plurality of broadcasting stations;
extracting a set of information for specifying interactive service having a relation to said computer for carrying out said interactive service and information for specifying service time of that interactive service by using the received information for specifying said interactive service; and
controlling activation and deactivation of each said interactive service based on said extracted set of said information for specifying said interactive service and said information for specifying said service time of that interactive service.

8. The method as set forth in claim 7, wherein in said step of controlling said activation and deactivation, if it is judged that a service start time has arrived based on said information for specifying said service time, a flag of the corresponding interactive service is set ON,
if it is judged that a service termination time has arrived based on said information for specifying said service time, a flag of the corresponding interactive service is set OFF, and
an interactive service is activated or deactivated based on said flag of said interactive service.

9. The method as set forth in claim 7, further comprising the steps of:
acquiring information indicating an operating state of said interactive service; and
transmitting said information indicating said operating state of said interactive service to a computer associated with said data broadcasting.

10. The method as set forth in claim 9, wherein said acquiring step includes a step of specifying that the interactive service is active in a case where a response indicating that the interactive service is active is received from the interactive service.

11. A program embodied on a medium, for causing a computer to control interlock of an interactive service with data broadcasting, said program comprising the steps of:
acquiring information for specifying an interactive service associated with data broadcasting and information for specifying a service time of said interactive service;
transmitting said information for specifying said interactive service and said information for specifying said service time, which are acquired in said acquiring step, to a computer for providing said interactive service.

12. The program as set forth in claim 11, wherein said acquiring step includes a step of extracting said information for specifying said interactive service and said information for specifying said service time from interactive service organization information.

13. The program as set forth in claim 12, wherein said acquiring step further includes a step of extracting second information for specifying said interactive service from content information of said data broadcasting and comparing the second extracted information with said information for specifying said interactive service extracted from said interactive service organization information.

14. The program as set forth in claim 11, wherein in said transmitting step, said information for specifying said interactive service and said information for specifying said service time, together with content information of said data broadcasting, are distributed to said computer for providing said interactive service.

15. The program as set forth in claim 11, further comprising a step of generating information as to whether each interactive service must be activated at present based on said information for specifying said service time of each said interactive service, and
wherein in said transmitting step, said information as to whether each said interactive service must be activated at present is further transmitted.

16. The program as set forth in claim 11, further comprising a step of, if information indicating an operating state of said interactive service is received from said computer for providing said interactive service, deleting or invalidating designation of an inactive interactive service in content information of said data broadcasting.

17. A program embodied on a medium, for causing a computer for carrying out an interactive service associated with data broadcasting to control interlock of the interactive service with said data broadcasting, said program comprising the steps of:
receiving a set of information for specifying an interactive service and information for specifying a service time of said interactive service from a computer in one or a plurality of broadcasting stations;
extracting a set of information for specifying interactive service having a relation to said computer for carrying out said interactive service and information for specifying service time of that interactive service by using the received information for specifying said interactive service; and
controlling activation and deactivation each said interactive service based on said extracted set of said information for specifying said interactive service and said information for specifying said service time of that interactive service.

18. The program as set forth in claim 17, wherein in said step of controlling said activation and deactivation, if it is judged that a service start time has arrived based on said information for specifying said service time, a flag of the corresponding interactive service is set ON,
if it is judged that a service termination time has arrived based on said information for specifying said service time, a flag of the corresponding interactive service is set OFF, and
an interactive service is activated or deactivated based on said flag of said interactive service.

19. The program as set forth in claim 17, further comprising the steps of:
acquiring information indicating an operating state of said interactive service; and
transmitting said information indicating said operating state of said interactive service to a computer associated with said data broadcasting.

20. The program as set forth in claim 19, wherein said acquiring step includes a step of specifying that the interactive service is active in a case where a response indicating that the interactive service is active is received from the interactive service.

21. An apparatus for controlling interlock of an interactive service with data broadcasting, comprising:
means for acquiring information for specifying an interactive service associated with data broadcasting and information for specifying a service time of said interactive service;
a transmitter for transmitting said information for specifying said interactive service and said information for specifying said service time, which are acquired by said means for acquiring, to a computer for providing said interactive service.

22. The apparatus as set forth in claim 21, wherein said means for acquiring includes means for extracting said information for specifying said interactive service and said information for specifying said service time from interactive service organization information.

23. The apparatus as set forth in claim 22, wherein said means for acquiring further includes means for extracting second information for specifying said interactive service from content information of said data broadcasting and for comparing the second extracted information with said information for specifying said interactive service extracted from said interactive service organization information.

24. The apparatus as set forth in claim 21, wherein said transmitter distributes said information for specifying said interactive service and said information for specifying said service time, together with content information of said data broadcasting to said computer for providing said interactive service.

25. The apparatus as set forth in claim 21, further comprising a generator for generating information as to whether each interactive service must be activated at present based on said information for specifying said service time of each said interactive service, and
wherein said transmitter further transmits said information as to whether each said interactive service must be activated at present.

26. The apparatus as set forth in claim 21, further comprising:
means for deleting or invalidating designation of an inactive interactive service in content information of said data broadcasting, if information indicating an operating state of said interactive service is received from said computer for providing said interactive service,

27. A computer system for carrying out an interactive service associated with data broadcasting, comprising:
a receiver for receiving a set of information for specifying an interactive service and information for specifying a service time of said interactive service from a computer in one or a plurality of broadcasting stations;
means for extracting a set of information for specifying interactive service having a relation to said computer for carrying out said interactive service and information for specifying service time of that interactive service by using the received information for specifying said interactive service; and
means for controlling activation and deactivation of each said interactive service based on said extracted set of said information for specifying said interactive service and said information for specifying said service time of that interactive service.

28. The computer system as set forth in claim 27, wherein if it is judged that a service start time has arrived based on said information for specifying said service time, said means for controlling said activation and deactivation sets a flag of the corresponding interactive service ON,
if it is judged that a service termination time has arrived based on said information for specifying said service time, said means for controlling said activation and deactivation sets a flag of the corresponding interactive service OFF, and
said means for controlling said activation and deactivation activates or deactivates the interactive service on the basis of said flag of said interactive service.

29. The computer system as set forth in claim 27, further comprising:
means for acquiring information indicating an operating state of said interactive service; and
means for transmitting said information indicating said operating state of said interactive service to a computer associated with said data broadcasting.

30. The computer system as set forth in claim 29, wherein said means for acquiring comprises means for specifying that the interactive service is active in a case where a response indicating that the interactive service is active is received from the interactive service.
